(19) United States
(12) Patent Application Publication
(10) Pub. No.: US 2023/0200348 A1
(43) Pub. Date: Jun. 29, 2023

(54) CONNECTING RINGS FOR SMALL ANIMAL HABITAT PARTS

(71) Applicant: PetSmart Home Office, Inc., Phoenix, AZ (US)

(72) Inventor: Paul Tamulewicz, Glendale, AZ (US)

(73) Assignee: PetSmart Home Office, Inc., Phoenix, AZ (US)

(21) Appl. No.: 17/563,534

(22) Filed: Dec. 28, 2021

(51) Int. Cl. A01K 1/03; F16B 7/04

(52) U.S. Cl. CPC A01K 1/03; F16B 7/0406

(57) ABSTRACT

A connecting ring for coupling small animal habitat parts. The connecting ring can include a hoop, upper tabs projecting from an upper surface of the hoop, and lower tabs projecting from a lower surface of the hoop. The lower surface of the hoop is opposing the upper surface. Each of the upper tabs can include: a respective inner bump extending radially inward toward an interior of the hoop, and a respective inner groove formed between a respective lower surface of the respective inner bump and the upper surface of the hoop. Each of the lower tabs can include a respective outer bump extending radially outward away from the interior of the hoop, and a respective outer groove formed between a respective upper surface of the respective outer bump and the lower surface of the hoop. Other embodiments are disclosed.

### TECHNICAL FIELD

This disclosure relates generally to connecting rings and methods for using a connecting ring to couple together adjacent objects.

### BACKGROUND

Small animal habitats can be assembled, reconfigured, and extended to create different living environments for pets to rest, exercise, explore, and play. These habitats have been popular among owners of small pets, such as hamsters, gerbils, mice, etc. Such habitats generally include parts, such as tubes, cages, floor panels, wall panels, etc., in addition to connectors for coupling together these parts. Whether the connectors can effortlessly couple to the parts is key to easy and quick assembly of small animal habitats.

### BRIEF DESCRIPTION OF THE DRAWINGS

To facilitate further description of the embodiments, the following drawings are provided in which:

FIG. 1 illustrates a front perspective view of a connecting ring for small animal habitat parts, according to an embodiment;

FIG. 2 illustrates a top plan perspective view of the connecting ring of FIG. 1, according to an embodiment;

FIG. 3 illustrates a side elevation view of the connecting ring of FIG. 1, along arrow C of FIG. 2, according to an embodiment;

FIG. 4 illustrates a cross section view of the connecting ring of FIG. 1, along section line A-A in FIG. 2, according to an embodiment;

FIG. 5 illustrates a cross section view of the connecting ring of FIG. 4 coupled to a tubular end of an object, according to an embodiment;

FIG. 6 illustrates cross section view of the connecting ring of FIG. 1, along section line B-B in FIG. 2, according to an embodiment;

FIG. 7 illustrates a cross section view of the connecting ring of FIG. 6 coupled to a radially inwardly edge of another object, according to an embodiment;

FIG. 8 illustrates a side elevation view of a connecting ring, according to an alternate embodiment;

FIG. 9 illustrates a side elevation view of a connecting ring, according to another embodiment; and

FIG. 10 illustrates a flow chart of a method for using a connecting ring to couple objects, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, five seconds, ten seconds, thirty seconds, one minute, five minutes, ten minutes, or fifteen minutes.

### DESCRIPTION OF EXAMPLES OF EMBODIMENTS

Various embodiments include a connecting ring for coupling objects, such as small animal habitat parts. In many embodiments, the connecting ring can comprise: (a) a hoop; (b) upper tabs; and (c) lower tabs. The hoop can comprise an upper surface and a lower surface opposing the upper surface. The upper tabs can project from the upper surface of the hoop. Each of the upper tabs can comprise a respective inner bump extending radially inward toward an interior of the hoop. Each of the upper tabs further can include a respective inner groove formed between a respective lower surface of the respective inner bump and the upper surface of the hoop. In several embodiments, each of the upper tabs can be spaced apart from each other.

In some embodiments, the lower tabs of the connecting ring can project from the lower surface of the hoop. Each of the lower tabs can include a respective outer bump extending radially outward away from the interior of the hoop. Each of the lower tabs also can include a respective outer groove formed between a respective upper surface of the respective outer bump and the lower surface of the hoop. In certain embodiments, each of the lower tabs can be spaced apart from each other.

In a number of embodiments, the connecting ring can be configured to be coupled to a tubular end of a first object, such as a small animal habitat part, e.g., a tube, a tunnel, or a cap, etc., by snapping over a ridged edge of the tubular end via the upper tabs. The respective inner bump of each of the upper tabs can be configured to slip over the ridged edge of the tubular end of the first object. In addition, the respective inner groove of each of the upper tabs can configured to retain the ridged edge of the tubular end of the first object. In some embodiments, the hoop further can include an inner flange configured to prevent the tubular end of the first object from first moving past the upper surface of the hoop and then moving past the lower surface of the hoop.

In several embodiments, the connecting ring additionally or alternatively can be configured to be coupled to a radially inwardly edge of a second object, such as a cage, a wall panel, or a floor panel of a small animal habitat, by snapping into an opening surrounded by the radially inwardly edge via the lower tabs. The respective outer bump of each of the lower tabs can be configured to slip into the opening surrounded by the radially inwardly edge of the second object. The respective outer groove of each of the lower tabs further can be configured to retain the radially inwardly edge of the second object. In a few embodiments, the hoop further can comprise an outer flange configured to prevent the radially inwardly edge of the second object from first moving past the lower surface of the hoop and then moving past the upper surface of the hoop.

In some embodiments, the lower tabs and the upper tabs can be arranged alternately with each other around the connecting ring. In a number of embodiments, the connecting ring can include an elastic polymer material, such as acrylonitrile butadiene styrene (ABS) polymer, polycarbonates (PC) polymer, a mix of ABS and PC polymers, or any suitable materials or their various combinations. In certain embodiments, the respective inner groove of the each of the upper tabs can have a respective depth between 0.015 inch (0.3810 mm) and 0.027 inch (0.6858 mm). In similar or alternate embodiments, the respective outer groove of the each of the lower tabs has a respective depth between 0.01 inch (0.2540 mm) and 0.025 inch (0.6350 mm).

In a number of embodiments, each of the upper tabs further can include: a respective outer bump projecting radially outwardly, and a respective outer groove formed between a respective lower surface of the respective outer bump of the each of the upper tabs and the upper surface of the hoop. In several embodiments, each of the lower tabs can further include a respective inner bump projecting radially inwardly, and a respective inner groove formed between a respective upper surface of the respective inner bump of the each of the lower tabs and the lower surface of the hoop.

In a few embodiments, the connecting ring can be configured to be coupled to one or two of: (a) a tubular end of a first object by snapping over a ridged edge of the tubular end of the first object via the upper tabs; (b) a radially inwardly edge of a second object by snapping into an opening surrounded by the radially inwardly edge of the second object via the lower tabs; (c) a tubular end of a third obj ect by snapping over a ridged edge of the tubular end of the third object via the lower tabs; and/or (d) a radially inwardly edge of a fourth object by snapping into an opening surrounded by the radially inwardly edge of the fourth object via the upper tabs.

Various embodiments comprise a method of coupling a connecting ring to an object. In many embodiments, the method can comprise: (a) providing the connecting ring; and (b) snapping the connecting ring on the object. An exemplary connecting ring can include: (a) a hoop with an upper surface and a lower surface opposing the upper surface; (b) upper tabs projecting from the upper surface of the hoop; and (c) lower tabs projecting from the lower surface of the hoop. In a number of embodiments, each of the upper tabs can comprise: (a) a respective inner bump extending radially inward toward an interior of the hoop; and (b) a respective inner groove formed between a respective lower surface of the respective inner bump and the upper surface of the hoop. In some embodiments, each of the lower tabs can comprise: (a) a respective outer bump extending radially outward away from the interior of the hoop; and (b) a respective outer groove formed between a respective upper surface of the respective outer bump and the lower surface of the hoop.

In a number of embodiments, when the object to be coupled to the connecting ring includes a tubular end with a ridged edge, snapping the connecting ring on the object can include snapping the upper tabs of the connecting ring over the ridged edge of the tubular end of the object. Snapping the upper tabs of the connecting ring over the ridged edge of the tubular end of the object further can comprise: (a) slipping the respective inner bump of the each of the upper tabs over the ridged edge of the tubular end of the object; and (b) allowing the respective inner groove of the each of the upper tabs to retain the ridged edge of the tubular end of the object.

When the object includes a radially inwardly edge surrounding an opening, snapping the connecting ring on the object in some embodiments can include snapping the lower tabs of the connecting ring into the opening surrounded by the radially inwardly edge of the object. Snapping the lower tabs of the connecting ring into the opening surrounded by the radially inwardly edge of the object further can comprise: (a) slipping the respective outer bump of the each of the lower tabs into the opening surrounded by the radially inwardly edge of the obj ect; and (b) allowing the respective outer groove of the each of the lower tabs to retain the radially inwardly edge of the object.

In some embodiments, the method additionally can include using the connecting ring to further couple the object, which is coupled to the connecting ring, to another object. Using the connecting ring to couple the object to another object can include: (a) when the connecting ring is snapped over the ridged edge of the tubular end of the object, snapping the lower tabs of the connecting ring into an opening surrounded by a radially inwardly edge of the another object; and (b) when the connecting ring is snapped into the opening surrounded by the radially inwardly edge of the object, snapping the upper tabs of the connecting ring over a ridged edge of a tubular end of the another obj ect.

In several embodiments, the hoop of the connecting ring coupled to the object further can include an inner flange configured to prevent the tubular end of the object from first moving past the upper surface of the hoop and then moving past the lower surface of the hoop. In a number of embodiments, the hoop also can include an outer flange configured to prevent the radially inward edge of the object from first moving past the lower surface of the hoop and then moving past the upper surface of the hoop. In some embodiments, the lower tabs and the upper tabs of the connecting ring can be arranged alternately with each other around the connecting ring.

In a number of embodiments, the connecting ring can comprise any suitable elastic polymer material, such as a combination of certain ABS polymer and PC polymer. In a few embodiments, the respective inner groove of each of the upper tabs can have a respective depth between 0.015 inch (0.3810 mm) and 0.027 inch (0.6858 mm). In certain embodiments, the respective outer groove of each of the lower tabs can include a respective depth between 0.01 inch (0.2540 mm) and 0.025 inch (0.6350 mm).

In many embodiments, each of the upper tabs further can include a respective outer bump extending radially outwardly, and a respective outer groove formed between a respective lower surface of the respective outer bump of the each of the upper tabs and the upper surface of the hoop. Each of the lower tabs further can include a respective inner bump extending radially inward, and a respective inner groove formed between a respective upper surface of the respective inner bump of the each of the lower tabs and the lower surface of the hoop.

When the upper tabs of the connecting ring are snapped over the ridged edge of the tubular end of the object, and when each of the lower tabs further includes the respective inner bump and the respective inner groove, using the connecting ring to further couple the object to another object can include snapping the lower tabs of the connecting ring over a ridged edge of a tubular end of the another object via the lower tabs. When the lower tabs of the connecting ring are snapped into the opening surrounded by the radially inwardly edge of the object, and when each of the upper tabs further comprises a respective outer bump and a respective outer groove, using the connecting ring to further couple the object to another object can include snapping the upper tabs of the connecting ring into the opening surrounded by the radially inwardly edge of the another object.

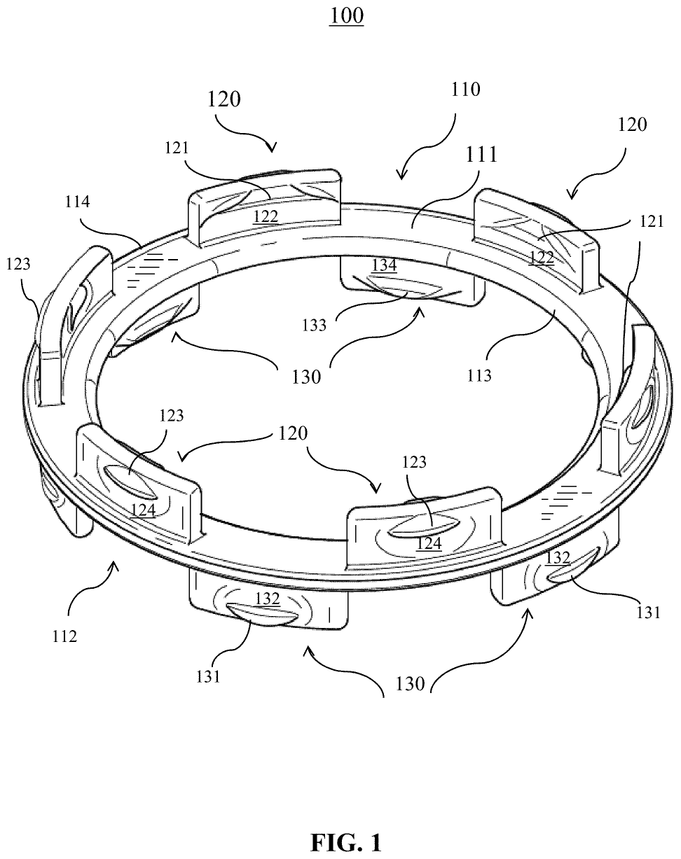

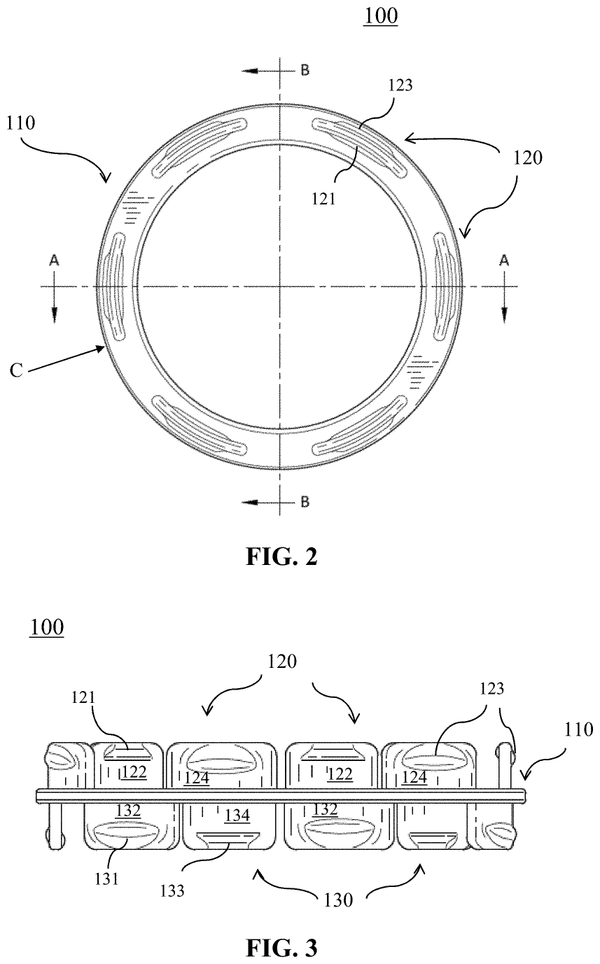

Turning to the drawings, FIGS. 1-7 illustrate various views of a connecting ring (100) for small animal habitat parts, according to an embodiment. As shown in FIGS. 1-7, the connecting ring (100) can include a hoop (110), upper tabs (120), and lower tabs (130). The upper tabs (120) and/or the lower tabs (130) can be of any suitable numbers, dimensions, shapes, and/or configurations. For example, each of the upper tabs (120) and/or the lower tabs (130) can be a triangle with or without a rounded top corner, a rectangle with or without one or more rounded corners, a trapezoid with or without one or more rounded corners, a semicircle, or a semi ellipse, etc. In other embodiments, one or more of the upper tabs (120) and the lower tabs (130) can have different shapes from the other ones of the upper tabs (120) and the lower tabs (130). In some embodiments, each of the upper tabs (120) can be evenly spaced apart from each other, and each of the lower tabs (130) can be evenly spaced apart from each other. In similar or alternate embodiments, each of the upper tabs (120) can be evenly spaced apart from each other, while not every space between each pair of adjacent lower tabs (130) is the same, or vice versa. The upper tabs (120) and the lower tabs (130) can be arranged alternately with each other around the connecting ring (110).

In many embodiments, the connecting ring (100) can be configured to snap on one or two objects such as small animal habitat parts (e.g., a tube, a tunnel, a wall panel, etc.), via the upper tabs (120) and/or the lower tabs (130). For example, as shown in FIG. 5, when a first object (500) includes a tubular end with a ridged edge (510), the connecting ring (100) can snap over the ridged edge (510) of the tubular end via the upper tabs (120). As shown in FIG. 7, when a second object (700) includes a radially inwardly edge (710) surrounding an opening, the connecting ring (100) can snap into the opening surrounded by the radially inwardly edge (710) via the lower tabs (130). The connecting ring (100) can couple the first object to the second object by snapping on the first object (e.g., 500) on a first side (e.g., the upper side of the hoop (110)) and the second object (e.g. 700) on a second side (e.g., the lower side of the hoop (110)).

In a number of embodiments, the connecting ring (100) can be configured to allow for 360 degrees of rotation to maintain flexibility in the positions or arrangements of the objects (e.g., 500 or 700 in FIGS. 5 and 7, respectively) to which the connecting ring (100) is coupled. The connecting ring (100) can comprise, entirely or in part, an elastic material, such as an elastic polymer material, including ABS polymer(s), PC polymer(s), and/or a combination thereof. The material(s) for the connecting ring (100) further can be chew-resistant to avoid damage by small animal(s).

Referring back to FIGS. 1-7, in many embodiments, the hoop (110) can include an upper surface (111) and a lower surface (112) opposing the upper surface (111). The hoop (110) further can include an inner flange (113) configured to prevent a tubular end of a small animal habitat part (e.g., a tube or a tunnel, etc.) from first moving past the upper surface (111) of the hoop (110) and then moving past the lower surface (112) of the hoop (110). The hoop (110) additionally can include an outer flange (114) configured to prevent the radially inwardly edge of another small animal habitat part (e.g., a floor/wall pane of a cage or a playpen, etc.) from first moving past the lower surface (112) of the hoop (110) and then moving past the upper surface (111) of the hoop (110). The inner flange (113) and/or the outer flange (114) can be of any suitable dimensions, shapes, and/or configurations. For example, the inner flange (113) and/or the outer flange (114) each can be substantially circular, rectangular, triangular, elliptical, etc. The shape of inner flange (113) and the shape of the outer flange (114) can be similar or different to each other, and the shapes are not dependent upon the shape of the hole in the tube (such as the first object (500) in FIG. 5) or the shape of the hole in the wall panel of the cage (such as the second object (700) in FIG. 7) to which the connecting ring (100) is connected.

Further, as shown in FIGS. 1-7, the upper tabs (120) can project from the upper surface (111) of the hoop (110). Each of the upper tabs (120) can include a respective inner bump (121) extending radially inward toward an interior of the hoop (110). Each of the upper tabs (120) further can include a respective inner groove (122) formed between a respective lower surface of the respective inner bump (121) and the upper surface (111) of the hoop (110). To snap on an object (e.g., 500 in FIG. 5) including a tubular end with a ridged edge (e.g., 510 in FIG. 5), the respective inner bump (121) of each of the upper tabs (120) can be configured to slip over the ridged edge (e.g., 510 in FIG. 5) of the tubular end, and the respective inner groove (122) of the each of the upper tabs (121) can be configured to retain the ridged edge (e.g., 510 in FIG. 5) of the tubular end.

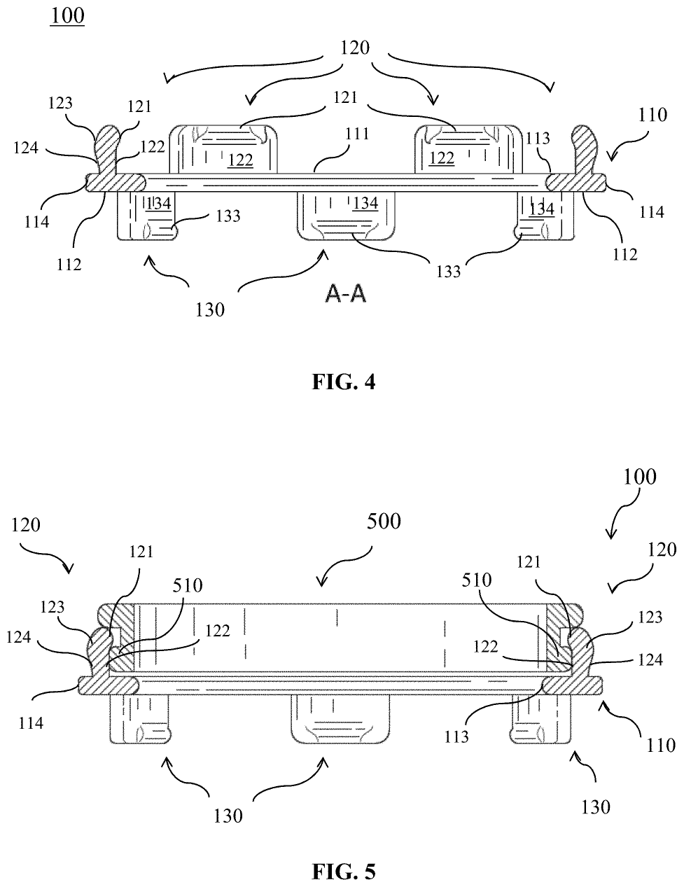

For example, in an embodiment where the upper tabs (120) are made of an elastic material, the respective inner bump (121) of each of the upper tabs (120), as shown in FIGS. 4-5, can include a respective leading profile with gradual radii that can lead up to the respective high spot of the respective inner bump (121) and thus enable the upper tabs (120) to easily slip over the ridged edge of the tubular end of a small animal habitat part (e.g., a tube such as the first object (500) in FIG. 5) and then return to a non-flex state when the ridged edge enters the respective inner groove (122).

Further, the respective inner groove (122) of each of the upper tabs (120) can have a respective depth measured from the high spot of the respective inner bump (121) to a respective area of the each of the upper tabs (120), between the respective inner bump (121) and the upper surface (111) of the hoop (110). The respective depth can be of any suitable dimension, such as 0.020 inch (0.5080 mm), 0.027 inch (0.6858 cm), or a dimension between 0.015 inch (0.3810 mm) and 0.040 inch (1.0160 mm), to retain a ridged edge of an object (e.g., a flange at a tubular end of a tube). The respective inner groove (122) of each of the upper tabs (120) further can include multiple respective interference points at the bottom surface of the respective inner bump (121) of the upper tabs (120) to collectively capture or attach an object via the resistance or grip at the contact points on the ridged edge of the object.

Moreover, the respective inner bump (121) and/or the respective inner groove (122) of each upper tab (120) can be of any suitable quantities, dimensions, shapes, and/or configurations. In some embodiments, the outer perimeter of the respective inner bump (121) can be substantially rectangular, triangular, trapezoid, elliptical, etc. In certain embodiments, a first upper tab (120) can include one or more respective inner bumps (121), and a second upper tab (120) also can include one or more respective inner bumps (121), while the one or more respective inner bumps (121) of the first upper tab (120) can be different from the one or more respective inner bumps (121) of the second upper tab (120), in quantity, dimension, shape, and/or configuration. The quantity, dimension, shape, and configuration of the one or more respective inner bumps (121) are not dependent upon the configuration of the tube (such as the first object (500) in FIG. 5) or the configuration of the hole in the wall panel of the cage (such as the second object (700) in FIG. 7) to which the connecting ring (100) is connected.

Continuing with FIGS. 1-7, the lower tabs (130) can project from the lower surface (112) of the hoop (110). Each of the lower tabs (130) can comprise a respective outer bump (131) extending radially outward away from the interior of the hoop (110). Each of the lower tabs (130) also can include a respective outer groove (132) formed between a respective upper surface of the respective outer bump (131) and the lower surface (112) of the hoop (110). When an object (e.g., 700 in FIG. 7) includes a radially inwardly edge (e.g., 710 in FIG. 7) surrounding an opening (e.g., a cage with an access hole), the respective outer bump (131) of each of the lower tabs (130) can be configured to slip into the opening surrounded by the radially inwardly edge of the obj ect, and the respective outer groove (132) of the each of the lower tabs (130) can be configured to retain the radially inwardly edge of the object.

In some embodiments, the respective outer groove (132) of each of the lower tabs (130) can have any suitable respective depth measured from the respective high spot of the respective outer bump (131) of the each of the lower tabs (130) to a respective area of the each of the lower tabs (130), between the respective outer bump (131) and the lower surface (112) of the hoop (110). For example, the respective depth can be 0.013 inch (0.3302 mm), 0.020 inch (0.5080 mm), 0.025 inch (0.6350 mm), or any dimension between 0.010 inch (0.2540 mm) and 0.040 inch (1.0160 mm), etc.

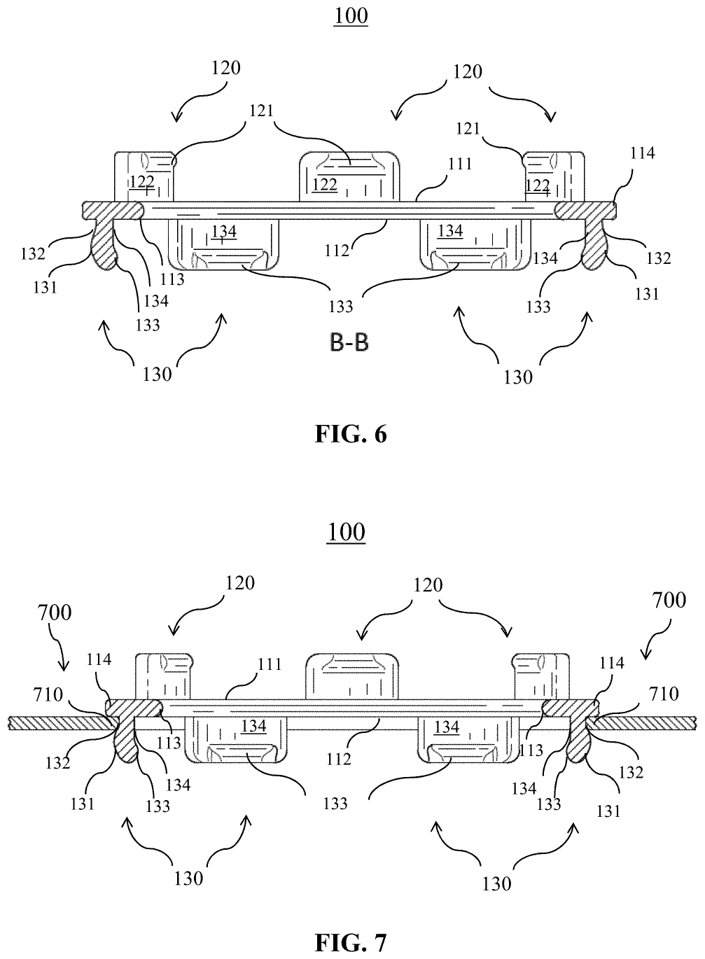

In embodiments where the lower tabs (130) are made of an elastic material, the respective outer bump (131) of each of the lower tabs (130), as shown in FIGS. 6-7, can include a respective leading profile with gradual radii that can lead up to the respective high spot of the respective outer bump (131) so that the lower tabs (120) can slip into an opening surrounded by an radially inwardly edge of a small animal habitat part (e.g., a cage such as second object (700) in FIG. 7 with an access hole) and then return to a non-flex state when the radially inwardly edge enters the respective outer groove (132). Further, once the radially inwardly edge of the object enters the respective outer groove (132) of each of the lower tabs (130), the lower tabs (130) can collectively capture or attach to the object via the resistance or grip at the contact points of the radially inwardly edge by respective interference points at the upper surface of the respective outer bump (131) of the each of the lower tabs (130).

Further, the respective outer bump (131) and/or the respective outer groove (132) of each lower tab (130) can be of any suitable quantities, dimensions, shapes, and/or configurations. In some embodiments, the outer perimeter of the respective outer bump (131) can be substantially rectangular, triangular, trapezoid, elliptical, etc. In a number of embodiments, a first lower tab (130) can include one or more respective outer bumps (131), and a second lower tab (130) also can include one or more respective outer bumps (131), while the one or more respective outer bump (131) of the first lower tab (130) can be different from the one or more respective outer bump (131) of the second lower tab (130), in quantity, dimension, shape, and/or configuration. The quantity, dimension, shape, and configuration of the one or more respective outer bumps (131) are not dependent upon the configuration of the tube (such as the first object (500) in FIG. 5) or the configuration of the hole in the wall panel of the cage (such as the second object (700) in FIG. 7) to which the connecting ring (100) is connected.

Still referring to FIGS. 1-7, each of the upper tabs (120) further can include a respective outer bump (123) projecting radially outwardly and a respective outer groove (124) formed between a respective lower surface of the respective outer bump (123) and the upper surface (111) of the hoop (110). The respective outer bump (123) of each of the upper tabs (120) can be configured so that the connecting ring (100) also can snap into an opening surrounded by a radially inwardly edge of an object (e.g., a wall panel of cage such as the second object (700) in FIG. 7) by slipping the respective outer bump (123) of the each of the upper tabs (120) into the opening until the radially inwardly edge of the object is retained in the respective outer groove (124) of the each of the upper tabs (120). Similar to the outer bumps (e.g., 131) and grooves (e.g., 132) of the lower tabs (130), the respective outer bump (123) and/or the respective outer groove (124) of each upper tab (120) can be of any suitable quantities, dimensions, shapes, and/or configurations. The respective outer bump (123) of each of the upper tabs (120) can be structurally identical or similar to the respective outer bump (131) of each of the lower tabs (130), or it can be structurally different from the respective outer bump (131) of each of the lower tabs (130). The respective outer groove (124) of each of the upper tabs (120) also can be identical or similar to the respective outer groove (132) of each of the lower tabs (130).

In several embodiments, each of the lower tabs (130) additionally can comprise a respective inner bump (133) projecting radially inwardly and a respective inner groove (134) formed between a respective upper surface of the respective inner bump (133) of the each of the lower tabs (130) and the lower surface (112) of the hoop (110). In similar or alternate embodiments, the connecting ring (110) can be configured to snap on an object (e.g., a tube of a similar small animal habitat such as the second object (500) of FIG. 5) via the lower tabs (130) when the respective inner bump (133) of each of the lower tabs (130) is configured to slip over the ridged edge (e.g., 510 (FIG. 5)) of the tubular end of the object (e.g., 500 (FIG. 5)), and the respective inner groove (122) of the each of the upper tabs (120) is configured to retain the ridged edge of the tubular end. Similar to the inner bumps (e.g., 121) and grooves (e.g., 122) of the upper tabs (120), the respective inner bump (133) and/or the respective inner groove (134) of each lower tab (130) can be of any suitable quantities, dimensions, shapes, and/or configurations. In some embodiments, the respective inner bump (133) of each of the lower tabs (130) can be identical or similar to the respective inner bump (121) of each of the upper tabs (120), or it can be structurally different from the respective inner bump (121) of each of the upper tabs (120). The respective inner groove (134) of each of the lower tabs (130) further can be identical or similar to the respective inner groove (122) of each of the upper tabs (120).

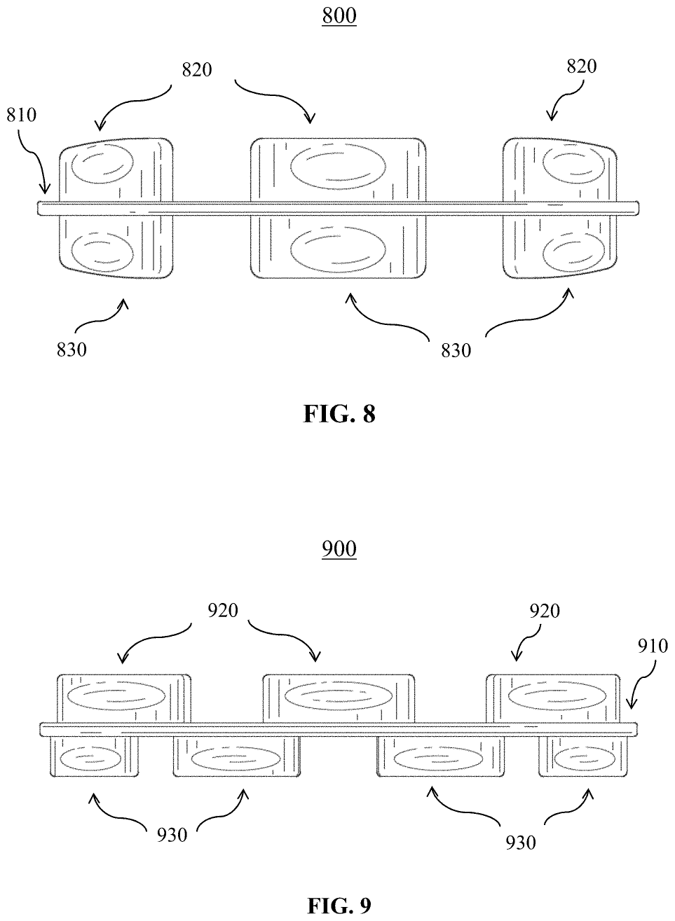

Turning ahead in the drawings, FIG. 8 illustrates a side elevation view of a connecting ring (800), according to an embodiment. In many embodiments, the connecting ring (800) can include a hoop (810), upper tabs (820), and lower tabs (830). The hoop (810), the upper tabs (820), and/or the lower tabs (830) can be structurally similar or identical to the hoop (110) (FIGS. 1-7), the upper tabs (120) (FIGS. 1-7), and/or the lower tabs (130) (FIGS. 1-7), respectively. The upper tabs (820) and the lower tabs (830) can be of any suitable numbers, dimensions, shapes, and/or configurations. For example, the connecting ring (800) can include 6 upper tabs (820) and 6 lower tabs (830). In a number of embodiments, the upper tabs (820) and the lower tabs (830) can be arranged symmetrically with each other around the connecting ring (810). The upper tabs (820) and/or the lower tabs (830) each can be substantially rectangular, triangular, trapezoid, and so forth, each with or without one or more rounded corners, or they can be semicircular, ellipsoidal, and so forth. In other embodiments one or more of the upper tabs (820) and the lower tabs (830) can have different shapes and/or can be evenly or unevenly spaced from the other ones of the upper tabs (820) and the lower tabs (830). The connecting ring (800) can comprise, entirely or in part, an elastic material. The material(s) for the connecting ring (800) further can be chew resistant.

Turning ahead in the drawings, FIG. 9 illustrates a side elevation view of a connecting ring, according to another embodiment. In many embodiments, the connecting ring (900) can include a hoop (910), upper tabs (920), and lower tabs (930). The hoop (910), the upper tabs (920), and/or the lower tabs (930) can be structurally similar or identical to the hoop (110 (FIG. 1-7) or 810 (FIG. 8)), the upper tabs (120 (FIG. 1-7) or 820 (FIG. 8)), and/or the lower tabs (130 (FIG. 1-7) or 830 (FIG. 8)), respectively. The upper tabs (920) and the lower tabs (930) can be of any suitable numbers, dimensions, shapes, and/or configurations. For example, the connecting ring (900) can include 6 upper tabs (920) and 8 lower tabs (930). The connecting ring (900) can comprise, entirely or in part, an elastic, chew resistant material.

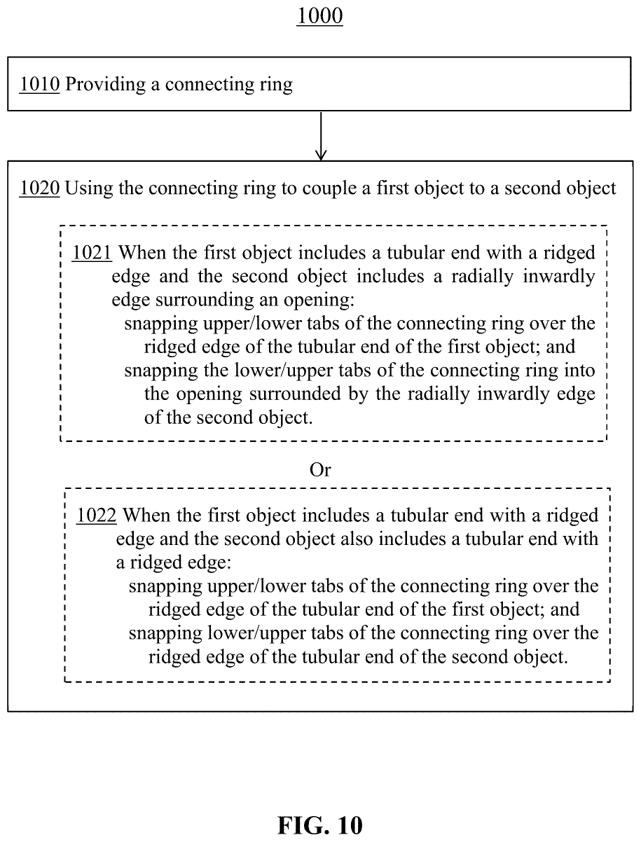

Turning ahead in the drawings, FIG. 10 illustrates a flow chart of a method (1000) for using a connecting ring (e.g., 100 (FIGS. 1-7), 800 (FIG. 8), or 900 (FIG. 9)) to couple objects (e.g., 500 (FIG. 5) and/or 700 (FIG. 7)), according to an embodiment. In many embodiments, the method (1000) can include: (a) providing a connecting ring (block 1010), and (b) using the connecting ring to couple a first object to a second object (block 1020). In a number of embodiments, the connecting ring provided in block (1010) can be similar or identical to any of the connecting rings disclosed herein (e.g., 100 (FIGS. 1-7), 800 (FIG. 8), or 900 (FIG. 9)).

For instance, the connecting ring can include: (a) a hoop (e.g., 110 (FIGS. 1-7), 810 (FIG. 8), or 910 (FIG. 9)); (b) upper tabs (e.g., 120 (FIGS. 1-7), 820 (FIG. 8), or 920 (FIG. 9)) projecting from an upper surface (e.g., 111 (FIGS. 1-7)) of the hoop; and (c) lower tabs (e.g., 130 (FIGS. 1-7), 830 (FIG. 8), or 930 (FIG. 9)) projecting from a lower surface (e.g., 112 (FIGS. 1-7)) of the hoop, the lower surface opposing the upper surface. Each of the upper tabs can include: a respective inner bump (e.g., 121 (FIGS. 1-7)) extending radially inward toward an interior of the hoop, and a respective inner groove (e.g., 122 (FIGS. 1-7)) formed between a respective lower surface of the respective inner bump and the upper surface of the hoop. Each of the lower tabs can include: a respective outer bump (e.g., 131 (FIGS. 1-7)) extending radially outward away from the interior of the hoop, and a respective outer groove (e.g., 131 (FIGS. 1-7)) formed between a respective upper surface of the respective outer bump and the lower surface of the hoop.

In many embodiments, using the connecting ring to couple the first object to the second object in block 1020 can include snapping the connecting ring (e.g., 100 (FIGS. 1-7), 800 (FIG. 8), or 900 (FIG. 9)) over the first object on a first side of the connector ring, and snapping the connecting ring over the second object on a second side of the connector ring. The second side can be opposing the first side. For example, the first side can be the upper side of the connecting ring while the second side is the lower side, or vice versa.

Still referring to FIG. 10, block 1020 further can include block 1021: when the first object includes a tubular end with a ridged edge (see, e.g., the object (500) with the ridged edge (510) (FIG. 5)) and the second object includes a radially inwardly edge surrounding an opening (see, e.g., the object (700) with the radially inwardly edge (710) (FIG. 7)), block 1020 can include: (a) snapping upper/lower tabs (e.g., 120 (FIGS. 1-7), 130 (FIGS. 1-7), 820 (FIG. 8), 830 (FIG. 8), 920 (FIG. 9), or 930 (FIG. 9)) of the connecting ring (e.g., 100 (FIGS. 1-7), 800 (FIG. 8), or 900 (FIG. 9)) over the ridged edge (e.g., 510 (FIG. 5)) of the tubular end of the first object; and (b) snapping the lower/upper tabs (e.g., 130 (FIGS. 1-7), 120 (FIGS. 1-7), 830 (FIG. 8), 820 (FIG. 8), 930 (FIG. 9), or 920 (FIG. 9)) of the connecting ring into the opening surrounded by the radially inwardly edge (e.g., 710 (FIG. 7)) of the second object.

In some embodiments, block 1020 further can include block 1022: when the first object includes a tubular end with a ridged edge (see, e.g., object 500 (FIG. 5)) and the second object also includes a tubular end with a ridged edge (see, e.g., object 500 (FIG. 5)), snapping upper/lower tabs (e.g., 120 (FIGS. 1-7), 130 (FIGS. 1-7), 820 (FIG. 8), 830 (FIG. 8), 920 (FIG. 9), or 930 (FIG. 9)) of the connecting ring over the ridged edge of the tubular end of the first object (e.g., the object (500) with the ridged edge (510) (FIG. 5)), and snapping lower/upper tabs (e.g., 130 (FIGS. 1-7), 120 (FIGS. 1-7), 830 (FIG. 8), 820 (FIG. 8), 930 (FIG. 9), or 920 (FIG. 9)) of the connecting ring over the ridged edge of the tubular end of the second object (e.g., the object (500) with the ridged edge (510) (FIG. 5)).

In a number of embodiments, snapping the upper/lower tabs of the connecting ring over the ridged edge of the tubular end of the first object in block 1021 or the second object in block 1022 further can include: (a) slipping the respective inner bump of the each of the upper/lower tabs over the ridged edge of the tubular end of the first/second object; and (b) allowing the respective inner groove of the each of the upper/lower tabs to retain the ridged edge of the tubular end of the first/second object.

In several embodiments, snapping the lower/upper tabs of the connecting ring into the opening surrounded by the radially inwardly edge of the second object in block 1021 further can include: (a) slipping the respective outer bump of the each of the lower tabs into the opening surrounded by the radially inwardly edge of the second object; and (b) allowing the respective outer groove of the each of the lower tabs to retain the radially inwardly edge of the second object.

Although systems and methods configured to provide or use a connecting ring for coupling small animal habitat parts have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any components of the connecting ring disclosed herein, as well as the steps to use the connecting ring, may be modified, and that the foregoing discussion of certain of these embodiments does not necessarily represent a complete description of all possible embodiments.

Replacement of one or more claimed elements constitutes reconstruction and not repair.

Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A connecting ring comprising:
a hoop comprising:
an upper surface; and
a lower surface opposing the upper surface;
upper tabs projecting from the upper surface of the hoop, wherein:
each of the upper tabs comprises:
a respective inner bump extending radially inward toward an interior of the hoop; and
a respective inner groove formed between a respective lower surface of the respective inner bump and the upper surface of the hoop; and
lower tabs projecting from the lower surface of the hoop, wherein:
each of the lower tabs comprises:
a respective outer bump extending radially outward away from the interior of the hoop; and
a respective outer groove formed between a respective upper surface of the respective outer bump and the lower surface of the hoop.

2. The connecting ring of claim 1, wherein the connecting ring is configured to be coupled to one or more of:
a tubular end of a first object by snapping over a ridged edge of the tubular end via the upper tabs; or
a radially inwardly edge of a second object by snapping into an opening surrounded by the radially inwardly edge via the lower tabs.

3. The connecting ring of claim 2, wherein one or more of:
(a) the respective inner bump of the each of the upper tabs is configured to slip over the ridged edge of the tubular end of the first object; and
the respective inner groove of the each of the upper tabs is configured to retain the ridged edge of the tubular end of the first object; or
(b) the respective outer bump of the each of the lower tabs is configured to slip into the opening surrounded by the radially inwardly edge of the second object; and
the respective outer groove of the each of the lower tabs is configured to retain the radially inwardly edge of the second object.

4. The connecting ring of claim 2, wherein:
the hoop further comprises one or more of:
an inner flange configured to prevent the tubular end of the first object from first moving past the upper surface of the hoop and then moving past the lower surface of the hoop; or
an outer flange configured to prevent the radially inwardly edge of the second object from first moving past the lower surface of the hoop and then moving past the upper surface of the hoop.

5. The connecting ring of claim 1, wherein the lower tabs and the upper tabs are arranged alternately with each other around the connecting ring.

6. The connecting ring of claim 1, wherein the connecting ring comprises an elastic polymer material.

7. The connecting ring of claim 6, wherein the elastic polymer material comprises acrylonitrile butadiene styrene polymer and polycarbonates polymer.

8. The connecting ring of claim 1, wherein:
the respective inner groove of the each of the upper tabs has a respective depth between 0.015 inch (0.3810 mm) and 0.027 inch (0.6858 mm); or
the respective outer groove of the each of the lower tabs has a respective depth between 0.01 inch (0.2540 mm) and 0.025 inch (0.6350 mm).

9. The connecting ring of claim 1, wherein:
the each of the upper tabs further comprises:
a respective outer bump projecting radially outwardly; and
a respective outer groove formed between a respective lower surface of the respective outer bump of the each of the upper tabs and the upper surface of the hoop; or
the each of the lower tabs further comprises:
a respective inner bump projecting radially inwardly; and
a respective inner groove formed between a respective upper surface of the respective inner bump of the each of the lower tabs and the lower surface of the hoop.

10. The connecting ring of claim 9, wherein the connecting ring is configured to be coupled to one or two of:
a tubular end of a first obj ect by snapping over a ridged edge of the tubular end of the first object via the upper tabs;
a radially inwardly edge of a second object by snapping into an opening surrounded by the radially inwardly edge of the second object via the lower tabs;
a tubular end of a third object by snapping over a ridged edge of the tubular end of the third object via the lower tabs; or
a radially inwardly edge of a fourth object by snapping into an opening surrounded by the radially inwardly edge of the fourth object via the upper tabs.

11. A method of coupling a connecting ring to an object, the method comprising:
providing the connecting ring, the connecting ring comprising:
a hoop comprising:
an upper surface; and
a lower surface opposing the upper surface;
upper tabs projecting from the upper surface of the hoop, wherein:
each of the upper tabs comprises:
a respective inner bump extending radially inward toward an interior of the hoop; and
a respective inner groove formed between a respective lower surface of the respective inner bump and the upper surface of the hoop; and
lower tabs projecting from the lower surface of the hoop, wherein:
each of the lower tabs comprises:
a respective outer bump extending radially outward away from the interior of the hoop; and
a respective outer groove formed between a respective upper surface of the respective outer bump and the lower surface of the hoop; and
snapping the connecting ring on the object by:
snapping the upper tabs of the connecting ring over a ridged edge of a tubular end of the object; or
snapping the lower tabs of the connecting ring into an opening surrounded by a radially inwardly edge of the object.

12. The method of claim 11, wherein:
snapping the upper tabs of the connecting ring over the ridged edge of the tubular end of the object further comprises:
slipping the respective inner bump of the each of the upper tabs over the ridged edge of the tubular end of the object; and
allowing the respective inner groove of the each of the upper tabs to retain the ridged edge of the tubular end of the object; or
snapping the lower tabs of the connecting ring into the opening surrounded by the radially inwardly edge of the object further comprises:
slipping the respective outer bump of the each of the lower tabs into the opening surrounded by the radially inwardly edge of the object; and
allowing the respective outer groove of the each of the lower tabs to retain the radially inwardly edge of the object.

13. The method of claim 11 further comprising:
using the connecting ring to further couple the object to another object by:
when the connecting ring is snapped over the ridged edge of the tubular end of the object, snapping the lower tabs of the connecting ring into an opening surrounded by a radially inwardly edge of the another object; and
when the connecting ring is snapped into the opening surrounded by the radially inwardly edge of the object, snapping the upper tabs of the connecting ring over a ridged edge of a tubular end of the another object.

14. The method of claim 11, wherein:
the hoop further comprises one or more of:
an inner flange configured to prevent the tubular end of the object from first moving past the upper surface of the hoop and then moving past the lower surface of the hoop; or
an outer flange configured to prevent the radially inward edge of the object from first moving past the lower surface of the hoop and then moving past the upper surface of the hoop.

15. The method of claim 11, wherein the lower tabs and the upper tabs of the connecting ring are arranged alternately with each other around the connecting ring.

16. The method of claim 11, wherein the connecting ring comprises an elastic polymer material.

17. The method of claim 16, wherein the elastic polymer material comprises acrylonitrile butadiene styrene polymer and polycarbonates polymer.

18. The method of claim 11, wherein:
the respective inner groove of the each of the upper tabs has a respective depth between 0.015 inch (0.3810 mm) and 0.027 inch (0.6858 mm); or
the respective outer groove of the each of the lower tabs has a respective depth between 0.01 inch (0.2540 mm) and 0.025 inch (0.6350 mm)..

19. The method of claim 11, wherein:
the each of the upper tabs further comprises:
a respective outer bump extending radially outwardly; and
a respective outer groove formed between a respective lower surface of the respective outer bump of the each of the upper tabs and the upper surface of the hoop; or
the each of the lower tabs further comprises:
a respective inner bump extending radially inward; and
a respective inner groove formed between a respective upper surface of the respective inner bump of the each of the lower tabs and the lower surface of the hoop.

20. The method of claim 19 further comprising:
using the connecting ring to further couple the object to another object by:
when the upper tabs of the connecting ring are snapped over the ridged edge of the tubular end of the object:
snapping the lower tabs of the connecting ring into an opening surrounded by a radially inwardly edge of the another object; or
snapping the lower tabs of the connecting ring over a ridged edge of a tubular end of the another object via the lower tabs; and
when the lower tabs of the connecting ring are snapped into the opening surrounded by the radially inwardly edge of the object:
snapping the upper tabs of the connecting ring over the ridged edge of the tubular end of the another object; or
snapping the upper tabs of the connecting ring into the opening surrounded by the radially inwardly edge of the another object.
